(19) United States
(12) Patent Application Publication
(10) Pub. No.: US 2006/0288421 A1
(43) Pub. Date: Dec. 21, 2006

(54) Methods and apparatuses for reviewing general public licenses

(76) Inventors: Ivy S. Tsai, San Jose, CA (US); Harold Aaron Ludtke, San Jose, CA (US); Nicholas Szeto, Dublin, CA (US)

Correspondence Address: Richard H. Butler, 5655 Silver Creek Valley Road, #106, San Jose, CA, 95138, US

(21) Appl. No.: 11/153,962

(22) Filed: Jun. 15, 2005

(51) Int. Cl. H04N 7/16

(52) U.S. Cl. 726/26

(57) ABSTRACT

In one embodiment, the methods and apparatuses detect a first right corresponding to a first license and a second right corresponding to a second license; compare a first status corresponding to the first right to a second status corresponding to the second right; and determine compatibility between the first license and the second license based on matching the first status and the second status.

### FIELD OF INVENTION

The present invention relates generally to reviewing licenses and, more particularly, to reviewing general public licenses.

### BACKGROUND

There has been a proliferation of general public licenses that allow licensees to utilize software packages according to agreed upon licensing terms and conditions. While these general public licenses allow licensees to utilize the corresponding software package for little or no monetary costs, the licensing terms and conditions for each software package can vary.

In some cases, it is beneficial to combine separate software subject to a general public license into a single application. However, the licensing terms and conditions for separate software packages can pose a conflict with each other. For example, in the terms and conditions of a first software general public license, the verbatim copies of source code and binaries are allowed. In the terms and conditions of a second software general public license, the verbatim copies of source code and binaries are not allowed. Accordingly, the first software general public license can be in conflict with the second software general public license.

### SUMMARY

In one embodiment, the methods and apparatuses detect a first right corresponding to a first license and a second right corresponding to a second license; compare a first status corresponding to the first right to a second status corresponding to the second right; and determine compatibility between the first license and the second license based on matching the first status and the second status.

### BRIEF DESCRIPTION OF THE DRAWINGS

The accompanying drawings, which are incorporated in and constitute a part of this specification, illustrate and explain one embodiment of the methods and apparatuses for reviewing general public licenses. In the drawings,

FIG. 1 is a diagram illustrating an environment within which the methods and apparatuses for reviewing general public licenses are implemented;

FIG. 2 is a simplified block diagram illustrating one embodiment in which the methods and apparatuses for reviewing general public licenses are implemented;

FIG. 3 is a simplified block diagram illustrating a system, consistent with one embodiment of the methods and apparatuses for reviewing general public licenses;

FIG. 4 is an exemplary record for use with the methods and apparatuses for reviewing general public licenses;

FIG. 5 is an exemplary rules listing for use with the methods and apparatuses for reviewing general public licenses;

FIG. 6 is a flow diagram consistent with one embodiment of the methods and apparatuses for reviewing general public licenses; and

FIG. 7 is a flow diagram consistent with one embodiment of the methods and apparatuses for reviewing general public licenses.

### DETAILED DESCRIPTION

The following detailed description of the methods and apparatuses for reviewing general public licenses refers to the accompanying drawings. The detailed description is not intended to limit the methods and apparatuses for reviewing general public licenses. Instead, the scope of the methods and apparatuses for reviewing general public licenses are defined by the appended claims and equivalents. Those skilled in the art will recognize that many other implementations are possible, consistent with the present invention.

References to a “device” include a device utilized by a user such as a computer, a portable computer, a personal digital assistant, a cellular telephone, and a device capable of receiving/transmitting an electronic message.

References to a “module” include a portion of software. In some instances, the module corresponds to at least one license.

References to a “license” include terms of the license such as rights, requirements, and restrictions.

In one embodiment, the methods and apparatuses for reviewing general public licenses allows the terms of a license pertaining to software to be modeled into a record data structure. Further, the terms of the license are expressed as rights, requirements, and restrictions in one embodiment.

In one embodiment, a license is associated with a module. In another embodiment, multiple licenses are associated with a module. In one embodiment, the methods and apparatuses are configured to check licenses associated with the module for compatibility with each license and to aggregate the limitations of the licenses. In one embodiment, multiple modules that are each associated with at least one license are checked for compatibility with each other (e.g. when multiple modules are aggregated into a greater module that is distributed under the combination of licenses and/or a new license). Further, a listing of limitations by the licenses are determined over multiple modules.

In one embodiment, if there is a conflict or potential conflict between licenses, the methods and apparatuses highlight the right that triggers the conflict or potential conflict.

In one embodiment, the methods and apparatuses allow a user to associate at least one license with a module. Further, analysis of multiple licenses for compatibility and limitations are conducted. In one embodiment, licenses associated within a module are analyzed for compatibility and limitations. In another embodiment, multiple modules combined into another module are analyzed for compatibility and limitations with respect to the license(s) associated with each module and the license(s) of the combined module.

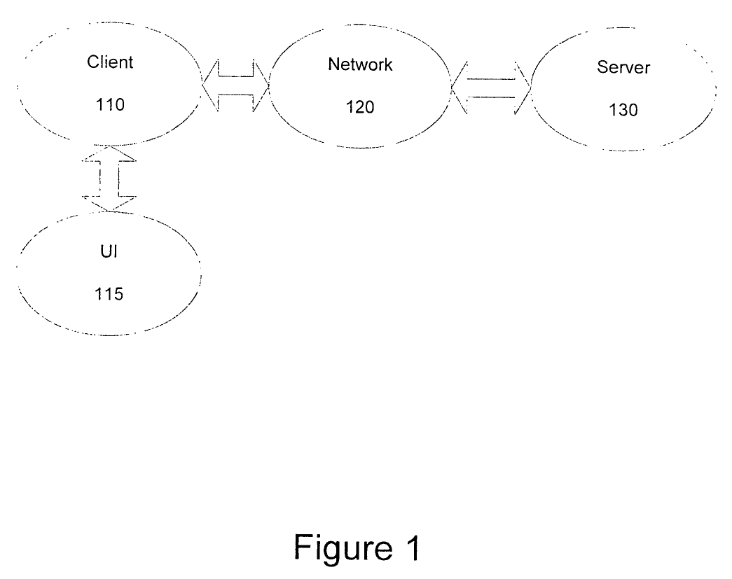

FIG. 1 is a diagram illustrating an environment within which the methods and apparatuses for reviewing general public licenses are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing such as a personal digital assistant. In other embodiments, one or more user interface 115 components (e.g., a keyboard, a pointing device such as a mouse, a trackball, etc.), a microphone, a speaker, a display, a camera are physically separate from, and are conventionally coupled to, electronic device 110. In one embodiment, the user utilizes interface 115 to access and control content and applications stored in electronic device 110, server 130, or a remote storage device (not shown) coupled via network 120.

In accordance with the invention, embodiments of reviewing general public licenses related to an event below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

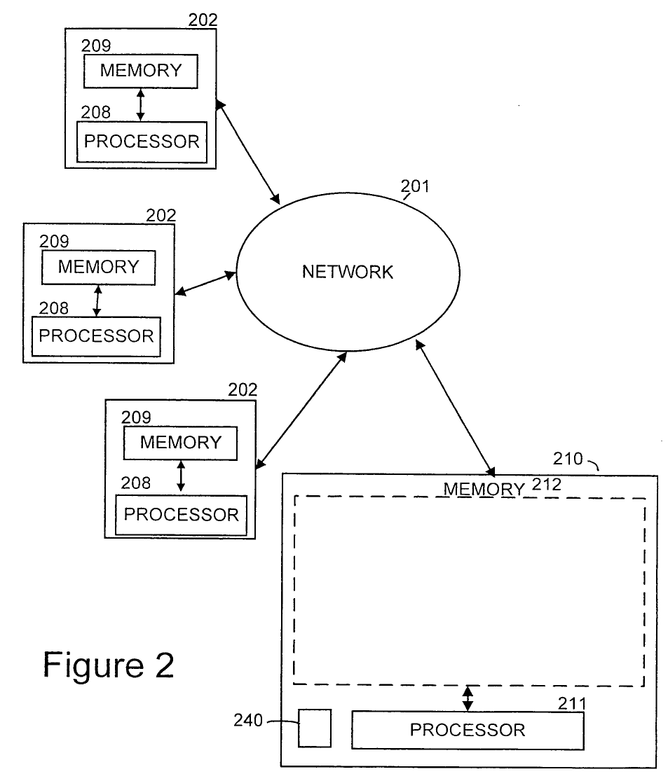

FIG. 2 is a simplified diagram illustrating an exemplary architecture in which the methods and apparatuses for reviewing general public licenses are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. In one embodiment, a unique user operates each electronic device 110 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 110 and the server 130 include instructions for a customized application for reviewing general public licenses. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on reviewing general public licenses as determined using embodiments described below.

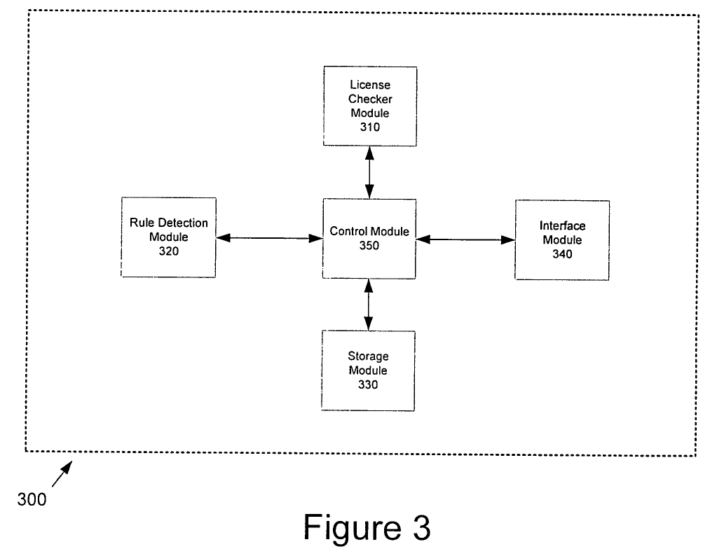

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a license checker module 310, a rule detection module 320, a storage module 330, an interface module 340, and a control module 350.

In one embodiment, the control module 350 communicates with the license checker module 310, the rule detection module 320, the storage module 330, and the interface module 340. In one embodiment, the control module 350 coordinates tasks, requests, and communications between the license checker module 310, the rule detection module 320, the storage module 330, and the interface module 340.

In one embodiment, the license checker module 310 compares the different rights, restrictions, and requirements that are associated with licenses. In one embodiment, the license checker module 310 determines whether a plurality of licenses are compatible with each other based on the rights, restrictions, and requirements associated with each license. For example, the license checker module 310 compares the rights, restrictions, and requirements of each license and determines compatibility of the licenses based on any contradictory rights, restrictions, and requirements. In one instance, if one license allows verbatim copies of the source code and binaries and the other license does not allow verbatim copies of the source code and binaries, then there is a potential incompatibility between the terms of both licenses.

In one embodiment, the license checker module 310 aggregates the rights, restrictions, and requirements of a plurality of licenses into a unified list of right, restrictions, and requirements that reflects the rights, restrictions, and requirements of the plurality of licenses. For example, one license may not specify a right that is specified in another license.

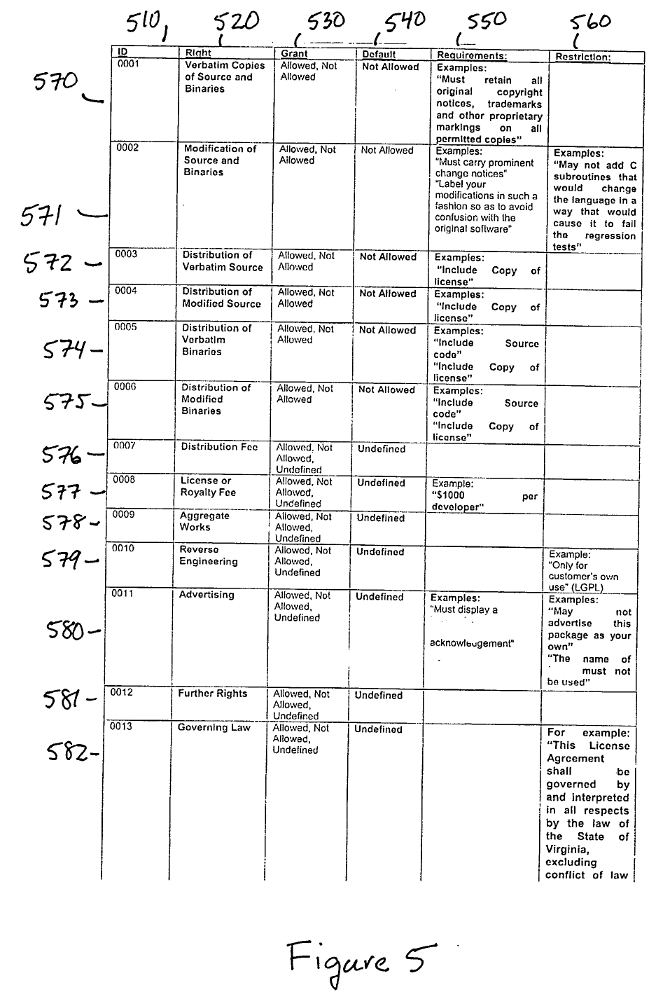

In one embodiment, the rights and rules detection module 320 detects the rights, restrictions, and requirements corresponding with a license associated with particular software. In one embodiment, the rights, restrictions, and requirements describe attributes of the license associated with the particular software. In one embodiment, the rights, restrictions, and requirements are modeled from a license associated with the particular software. For example, exemplary rights, restrictions, and requirements are shown in FIG. 5.

In one embodiment, when a particular portion of selected, the license corresponding to the particular portion of software and the rights and rules are detected by the rights and rules detection module 320.

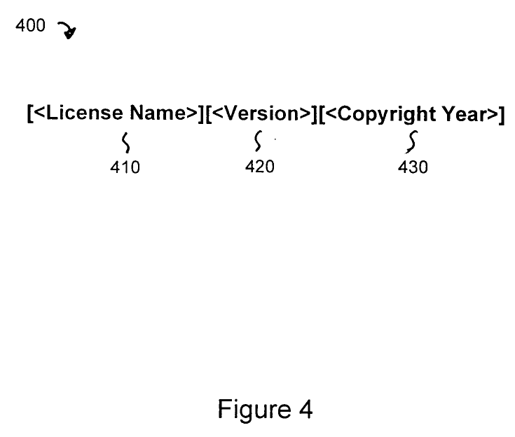

In one embodiment, the storage module 330 stores a record including the software identifier associated with a particular portion of software; and the rights, restrictions, and requirements corresponding with the license associated with the software identifier. For example, an exemplary software identifier contained within the record is illustrated in FIG. 4. Further, an exemplary rights, restrictions, and requirements listing is illustrated in FIG. 5.

In one embodiment, the interface module 340 receives a signal from one of the electronic devices 110 indicates portions of software that need to have their respective licenses checked is received by the system 300. In another embodiment, the interface module 340 delivers a signal to one of the electronic devices 110 indicating compatibility between a plurality of licenses. In yet another embodiment, the interface module 340 delivers a signal to one of the electronic devices 110 indicating the rights, restrictions, and requirements corresponding to a plurality of licenses.

The system 300 in FIG. 3 is shown for exemplary purposes and is merely one embodiment of the methods and apparatuses for reviewing general public licenses. Additional modules may be added to the system 300 without departing from the scope of the methods and apparatuses for reviewing general public licenses. Similarly, modules may be combined or deleted without departing from the scope of the methods and apparatuses for reviewing general public licenses.

FIG. 4 illustrates an exemplary record 400 for naming a license associated with a particular software. In one embodiment, there are multiple records such that each record 400 is associated with a license for a particular software. In one embodiment, the record 400 includes a license name field 410, a version field 420, and a copyright year field 430.

In one embodiment, the license name field 410 uniquely identifies the name of the particular software associated with the license. In one embodiment, the version field identifies the specific version of the particular software. In one embodiment, the copyright year field 430 identifies the year in which the particular software was copyrighted. The license name field 410, the version field 420, and/or the copyright year field 430 can be utilized to identify the particular software and the corresponding license.

FIG. 5 illustrates an exemplary record 500 containing rules, restrictions, and requirements for a license associated with a particular module. The rights, restrictions, and requirements within the record 500 are shown for exemplary purposes. For example, a license may contain all, some, or none of the rights, restrictions, and requirements enumerated within the record 500. In one embodiment, the record 500 includes an identification column 510, a rights column 520, a grant column 530, a default column 540, a requirements column 550, and a restriction column 560.

In one embodiment, the identification column 510 enumerates the particular right and identifies the row that is associated with the corresponding columns. For example, the identification “0003” within the identification column 510 corresponds with the sample row 572.

In one embodiment, the rights column 520 identifies the particular right.

In one embodiment, the grant column 530 lists the possible disposition status of the corresponding right. For example, a particular right may be “allowed”, “not allowed”, or “undefined”.

In one embodiment, the default column 540 identifies the default grant status of a particular right. For example, if the grant disposition status for a particular right is not specified, the default grant status becomes the utilized status.

In one embodiment, the requirements column 550 identifies any additional requirements that need to be met if the particular right is “allowed”.

In one embodiment, the restrictions column 560 identifies limitations when the particular right is “allowed”.

More specifically, the right corresponding with row 570 is “Verbatim copies of source code and binaries”. In this example, the options for grant disposition are either “allowed” or “not allowed”. If the grant disposition is not selected, the default setting is “not allowed” for this right. Further, an example of a requirement includes: “Must retain all original copyright notices, trademarks and other proprietary markings on all permitted copies.”

Further, the right corresponding with row 571 is “Modification of source code and binaries”. In this example, the options for grant are either “allowed” or “not allowed”. If the grant disposition is not selected, the default setting is “not allowed” for this right. Further, examples of a requirement include: “Must carry prominent change notices” and “Label your modification in such a fashion as to avoid confusion with the original software.” An example of a restriction for this right includes: “May not add C subroutines that would change the language in a way that would cause it to fail the regression tests.”

Further, the right corresponding with row 572 is “Distribution of verbatim source code.” In this example, the options for grant are either “allowed” or “not allowed”. If the grant disposition is not selected, the default setting is “not allowed” for this right. Further, examples of a requirement include: “Include a copy of the license.”

Further, the right corresponding with row 573 is “Distribution of modified source code.” In this example, the options for grant are either “allowed” or “not allowed”. If the grant disposition is not selected, the default setting is “not allowed” for this right. Further, examples of a requirement include: “Include a copy of the license.”

Further, the right corresponding with row 574 is “Distribution of verbatim binaries.” In this example, the options for grant are either “allowed” or “not allowed”. If the grant disposition is not selected, the default setting is “not allowed” for this right. Further, examples of a requirement include: “Include source code” and “Include a copy of the license.”

Further, the right corresponding with row 575 is “Distribution of modified binaries.” In this example, the options for grant are either “allowed” or “not allowed”. If the grant disposition is not selected, the default setting is “not allowed” for this right. Further, examples of a requirement include: “Include source code” and “Include a copy of the license.”

Further, the right corresponding with row 576 is “Distribution fee.” In this example, the options for grant are either “allowed”, “not allowed”, or “undefined.” If the grant disposition is not selected, the default setting is “undefined” for this right.

Further, the right corresponding with row 577 is “License or royalty fee.” In this example, the options for grant are either “allowed”, “not allowed”, or “undefined.” If the grant disposition is not selected, the default setting is “undefined” for this right. Further, an example of a requirement includes: “Fee of $1000 per developer.”

Further, the right corresponding with row 578 is “Aggregate works.” In this example, the options for grant are either “allowed”, “not allowed”, or “undefined.” If the grant disposition is not selected, the default setting is “undefined” for this right.

Further, the right corresponding with row 579 is “Reverse engineering.” In this example, the options for grant are either “allowed”, “not allowed”, or “undefined.” If the grant disposition is not selected, the default setting is “undefined” for this right. Further, an example of a restriction includes: “Only for customer's own use.”

Further, the right corresponding with row 580 is “Advertising.” In this example, the options for grant are either “allowed”, “not allowed”, or “undefined.” If the grant disposition is not selected, the default setting is “undefined” for this right. Further, an example of a requirement includes: “Must display a source origin acknowledgement.” Examples of restrictions include: “May not advertise this package as your own” and “The name of XXX University must not be used.”

Further, the right corresponding with row 581 is “Further rights.” In this example, the options for grant are either “allowed”, “not allowed”, or “undefined.” If the grant disposition is not selected, the default setting is “undefined” for this right.

Further, the right corresponding with row 582 is “Governing law.” In this example, the options for grant are either “allowed”, “not allowed”, or “undefined.” If the grant disposition is not selected, the default setting is “undefined” for this right. Further, an example of a restriction includes: “This license agreement shall be governed by and interpreted in all respects by the law of the state of Virginia excluding conflict of law.”

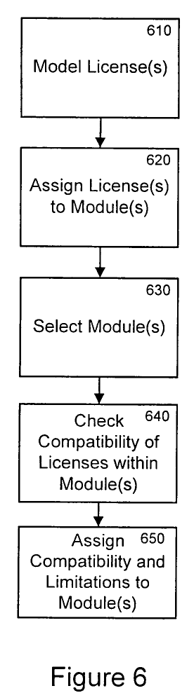

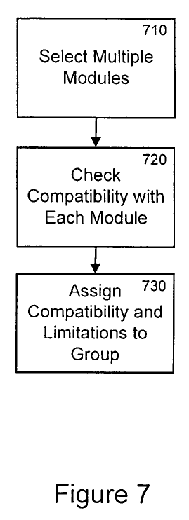

The flow diagrams as depicted in FIGS. 6 and 7 are one embodiment of the methods and apparatuses for reviewing general public licenses. The blocks within the flow diagrams can be performed in a different sequence without departing from the spirit of the methods and apparatuses for reviewing general public licenses. Further, blocks can be deleted, added, or combined without departing from the spirit of the methods and apparatuses for reviewing general public licenses.

The flow diagram in FIG. 6 illustrates reviewing licenses according to one embodiment of the invention.

In Block 610, a license is modeled. In one embodiment, a license is modeled into a format similar to the record 500. In one embodiment, the terms of the license are translated and described as rights, restrictions, and requirements. Exemplary rights, restrictions, and requirements are shown in the record 500. In another embodiment, the multiple licenses are modeled into a format similar to the record 500 wherein each license corresponds with a separate record.

In Block 620, a license is assigned to a software module. In one embodiment, if a portion of the software module utilizes software that corresponds with a license, this license is assigned to the software module. In another embodiment, multiple licenses are assigned to the software module.

In one embodiment, the system 300 identifies licenses that are related to the software module by identifying the relationships between different components and the software module. For example in one embodiment, these components can include headers, statically linked libraries, dynamically linked libraries, and the like. In one embodiment, licenses that are related to the components are also assigned to this software module.

In Block 630, a module is selected. In one embodiment, the licenses associated with the selected module are examined for compatibility and limitations.

In another embodiment, multiple modules are selected. In this instance, the licenses associated with each module are examined for compatibility and limitations based according to each module, and the compatibility and limitations of the modules are examined relative to each other. For example, if module A and module B are selected, then the licenses associated with the module A are examined for compatibility and limitations. The licenses associated with module B are examined for compatibility and limitations. If the licenses associated with module A and module B are compatible, then the licenses associated with module A and module B are examined for compatibility and limitations.

In Block 640, the licenses associated with the selected module(s) are examined for compatibility and limitations.

Each of the rights listed within the record 500 may include the following grant options: allowed, allowed with requirement, allowed with restriction, allowed with requirement and restriction, not allowed, and undefined. Depending on the particular right and the selected grant option for the particular right for each of the licenses, the licenses may not be compatible. In one embodiment, there is a conflict when the same right for a first license is “allowed” and the second license is “not allowed.” There is a potential conflict when the same right for the first license is “not allowed” and the second license is either “allowed with requirement”, “allowed with restriction”, or “allowed with restriction and requirement.” There is also a potential conflict when the same right for the first license is “allowed” and the second license is either “allowed with restriction”, “allowed with requirement”, or “allowed with restriction and requirement.” Further, there is also a potential conflict when the same right for the first license is “allowed with restriction and requirement” and the second license is either “allowed with restriction” or “allowed with requirement.” Further, there is also a potential conflict when the same right for the first license is “allowed with requirement” and the second license is “allowed with restriction.” In some of these instances, the determination of an actual conflict between these rights exists may depend on the additional limitations within the “restriction” or the “requirement.”

In some instances, different rights are also related. When these related rights listed in different licenses have grant statuses that do not match, there is a potential conflict between these licenses. In one embodiment, the right in row 581 is related to the rights in rows 570-580 and 582. For example, the right of “further rights” shown in row 581 as “not allowed” would have a potentially conflicted with any other rights shown in rows 570-580 and 582 as “allowed”, “allowed with restriction”, “allowed with requirement”, or “allowed with requirement and restriction.” In another embodiment, the right in row 570 is related to the rights in rows 572 and 574. In another embodiment, the right in row 571 is related to the rights in rows 573 and 575.

In Block 650, compatibility is determined and limitations are assigned to the module. In one embodiment, the licenses associated with the module are analyzed. Based on the analysis, the licenses compared within the module are determined to either be compatible or potentially incompatible. In one embodiment, if the licenses are potentially incompatible, then the particular rights that may cause the incompatibility are highlighted. In one instance, the incompatibility is listed and highlighted in a form similar to the record 500.

In one embodiment, if the licenses within the module are considered compatible, then the limitations set forth from the licenses are listed. For example, the grant status of the rights and any restrictions or requirements may be enumerated in a form similar to the record 500.

The flow diagram in FIG. 7 illustrates reviewing licenses according to one embodiment of the invention.

In Block 710, multiple modules are selected. In one embodiment, there are multiple licenses associated with each module. In another embodiment, there is one license associated with each module. In one embodiment, each module is represented by a record similar to the record 500. In an example with multiple licenses associated with each module, the licenses associated with each module are checked for compatibility within the module and have their limitations represented by a record. In another example with a single license associated with each module, the limitations associated with the license are represented by a record.

In Block 720, each module selected within the group of modules selected in the Block 710 are checked for compatibility against each other. The analysis for compatibility is similar to the analysis discussed in the Block 640.

In Block 730, compatibility is determined and limitations are assigned to the group of modules as selected in the Block 710. In one embodiment, the licenses associated within the module are analyzed. In one instance, the contents of each record representing a corresponding module are compared with each other. Based on the analysis, the selected modules are determined to either be compatible or potentially incompatible. In one embodiment, if the selected modules are potentially incompatible with each other, then the particular rights that may cause the incompatibility are highlighted. In one instance, the incompatibility is listed and highlighted in a record.

In one embodiment, if the selected modules are considered compatible, then the limitations set forth from the licenses are listed. For example, the grant status of the rights and any restrictions or requirements may be enumerated in a record that represents the selected modules.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method comprising:
detecting a first right corresponding to a first license and a second right corresponding to a second license;
comparing a first status corresponding to the first right to a second status corresponding to the second right; and
determining compatibility between the first license and the second license based on matching the first status and the second status.

2. The method according to claim 1 wherein the first status is allowed.

3. The method according to claim 1 wherein the first status is allowed with restriction.

4. The method according to claim 1 wherein the first status is allowed with requirement.

5. The method according to claim 1 wherein the first status is not allowed.

6. The method according to claim 1 wherein the first license and the second license is compatible when the first status matches the second status.

7. The method according to claim 1 wherein the first right matches the second right.

8. The method according to claim 1 wherein the first license and the second license correspond to a module.

9. The method according to claim 1 further comprising modeling the first license in terms of rights.

10. The method according to claim 1 further comprising listing limitations of the first license and the second license.

11. The method according to claim 1 wherein the first right is verbatim copies of source code and binaries.

12. The method according to claim 1 wherein the first right is modification of source code and binaries.

13. The method according to claim 1 wherein the first right is distribution of verbatim source code.

14. The method according to claim 1 wherein the first right is reverse engineering.

15. The method according to claim 1 wherein the first right is aggregate works.

16. The method according to claim 1 wherein the first right is advertising.

17. The method according to claim 1 wherein the first right is distribution fee.

18. A system comprising:
means for detecting a first right corresponding to a first license and a second right corresponding to a second license;
means for comparing a first status corresponding to the first right to a second status corresponding to the second right; and
means for determining compatibility between the first license and the second license based on matching the first status and the second status.

19. A method comprising:
detecting a first license associated with a first module and a second license associated with a second module;
detecting a first right corresponding to the first license and a second right corresponding to the second license;
comparing a first status of the first right to a second status of the second right; and
determining compatibility between the first module and the second module based on matching the first status and the second status.

20. The method according to claim 19 wherein the first right matches the second right.

21. The method according to claim 19 further comprising modeling the first license in terms of rights.

22. The method according to claim 19 further comprising listing limitations of the first license and the second license.

23. A system, comprising:
a storage module to store a record containing information regarding a first license;
a rule detection module to detect the record corresponding to the first license; and
a license checker module to compare the record corresponding to the first license with information corresponding to a second license.

24. The system according to claim 23 further comprising an interface module to form the record reflecting rights, requirements, and restrictions associated with the first license.

25. The system according to claim 23 wherein the information within the record includes rights, requirements, and restrictions associated with the first license.

26. A computer-readable medium having computer executable instructions for performing a method comprising:
detecting a first license associated with a first module and a second license associated with a second module;
detecting a first right corresponding to the first license and a second right corresponding to the second license;
comparing a first status of the first right to a second status of the second right; and
determining compatibility between the first module and the second module based on matching the first status and the second status.
